(19) United States
(12) Patent Application Publication
(10) Pub. No.: US 2021/0206430 A1
(43) Pub. Date: Jul. 8, 2021

(54) Automated Steering Control Mechanism and System for Wheeled Vehicles

(71) Applicant: EVA, LLC, Los Angeles, CA (US)

(72) Inventors: Donald Jack North, Los Angeles, CA (US); Chandler T. McDowell, San Jose, CA (US)

(73) Assignee: EVA, LLC, Los Angeles, CA (US)

(21) Appl. No.: 17/142,231

(22) Filed: Jan. 5, 2021

Related U.S. Application Data
(60) Provisional application No. 62/957,253, filed on Jan. 5, 2020.

(51) Int. Cl. B62D 9/00; B62D 11/04; B62D 61/06

(52) U.S. Cl. CPC B62D 9/002; B62D 61/065; B62D 11/04

(57) ABSTRACT

An approach for automated differentially steering either three-wheeled or four-wheeled vehicles in response to input data collected from sensors associated with characteristics of vehicular movement is suitable for vehicles that travel at speeds about or exceeding 15 miles/hour. An automated differential vehicular steering system comprising such an approach includes a drive control computer including a closed loop vehicular motional controller, a plurality of sensing systems comprised of one or more wheel sensors, one or more inertial sensors measuring vehicular movement, and software for modeling a response to outputs from the plurality of sensing systems. The design of the differential vehicular steering system enables improvements in autonomous or unmanned driving, as no user input is needed for steering.

This application claims the benefit of priority and is entitled to the filing date pursuant to 35 U.S.C. § 119(e) of U.S. Provisional Patent Application 62/957,253, filed Jan. 5, 2020, the content of which is hereby incorporated by reference in its entirety.

### FIELD

The present invention relates to the field of steering systems for vehicles. Specifically, the present invention relates to an automated steering system that differentially controls rotational movement of at least the front wheels of a vehicle through a feedback mechanism incorporating multiple sensors that continuously monitor different vehicular operating characteristics.

### BACKGROUND

There is a need for safe, affordable, sustainable, clean mobility solutions that people don't necessarily need to own and maintain. Traditional wheeled vehicles use Ackermann-based mechanical steering encompassing a geometry where the front steered wheels are horizontally rotated to follow individual turning radii from a central point along the fixed rear wheels' axis. This geometry when used with front-steered wheels is self-stabilizing while moving, however this geometry limits the minimum allowable turning radius and generally requires the front wheels to be exposed, harming aerodynamics. An alternative to Ackermann-based mechanical steering is differential steering. Differential steering works by actively adjusting the relative rolling speed of a left and right wheel. One way to accomplish this is by powering each wheel separately with its own motor. To move forward, equal power is applied to both wheels causing them to roll at equal speeds; turning is accomplished by actively rolling the wheels at different speeds through a differential in applied power between the motors. One example of differential steering is powered wheelchairs. Geometry dictates that a turning radius will require a certain speed difference between the inner and outer wheels. Unlike Ackermann-based mechanical steering, differential steering offers the capability of turning in place, i.e. zero turning radius, where the two wheels are rolling at equal speeds in opposite directions.

There are several examples of differential steering. Differentially steered powered wheelchairs are stable when making turns because their center of gravity is generally centered over the axis between the two powered wheels. They also generally are limited in speed for safety. With the center of gravity generally centered above the powered wheels, rapid stopping from a high speed could cause the vehicle to flip forward and injury to the rider. Some farm equipment, for example a swather, is also differentially steered via two powered front wheels. At the rear are two passive caster style wheels. With its center of gravity longitudinally located between the front and rear wheels, this geometry has the potential to oversteer or fishtail of the rear portion of the vehicle when making turns. Three- and four-wheel forklift trucks are rear-steered for improved maneuverability, however they are also susceptible to oversteering which cannot be easily corrected by the operator at speed. Accordingly, current differential steering vehicles are intended to be driven slowly below 15 miles/hour and may be speed limited for the operator to steer safely.

Approaches exist for differentially steering in individual wheels, such as in U.S. Patent Publication No. 2007/0295545. In this approach, an electronic control unit (ECU) receives speed commands from an operator's accelerator foot pedal, sensor inputs from the angular position of the rear steered wheel and operator's steering wheel, and front wheel speed sensors. Based on this input, the ECU provides commands to the steer motor in proportion to steering wheel position; and provides speed and torque commands to each of the electric motor front wheels. Such an approach is limited, however, in that it relies on input provided by an operator using a steering wheel to manually compensate for any oversteer and thus, is limited in maximum speed for safe travel, much like many forklifts and farming equipment. This means that such systems are not capable of reliable unmanned operation and incapable of safe higher speed operation typically encountered and allowed on city streets. Also, due to requiring an operator, the presence of additional mechanical parts increases manufacturing and operating costs, at least from having to monitor, maintain, and replace such parts.

Thus, differentially steering, regardless of the type of vehicle involved, encounter many issues that render widespread applicability, particular in the field of unmanned or autonomous vehicular operation, problematic. Accordingly there is a need in the existing art for an automated differential steering approach that allows for safe and stable travel at typical city speeds without the need for a rear steered wheel and/or an operator and which incorporates input data from sensors that continually monitor characteristics of vehicular movement in the x, y, and z spaces, and account for advanced analytics such as yaw, pitch, roll, and acceleration about the x, y, and z spaces to detect and automatically compensate for oversteer. There is also a need for an approach that reduces the number of mechanical parts needed for operating vehicles. There is also a need for an approach that increases reliability and maneuverability, particularly in cities where differential steering is incorporated in driverless vehicles.

### SUMMARY

The present invention addresses these issues by providing a proprietary approach for controlling directional movement for 3- or 4-wheeled vehicles for speeds over 15 miles/hour utilizing vehicle modeling and sensory input in an automated differential steering mechanism and framework embodied in one or more systems and methods. The automated differential steering mechanism and framework comprises a drive control computer, a plurality of sensors configured to continually measure vehicular motional characteristics, such as wheel sensors, inertial sensors including gyroscope(s), accelerometers, magnetometers, ultrasonic sensors, and other sensors such as ultrasonic, radar, LiDAR, cameras, GPS, configured to measure motion of the vehicle, and at least one closed loop vehicular motional controller. Vehicles in which the automated differential system mechanism and framework is implemented have two front wheels with an electric motor and a wheel sensor associated with each front wheel, and also have at least one rear wheel or optionally two rear wheels, which allow movement along the x-y plane, with the x-axis movement being forward or rearward movement and the y-axis movement being left and right side. The rear wheel(s) may also be associated with wheel sensor(s) and optionally actuated clutch(s) and/or electric motor(s) coupled to each rear wheel.

Target vehicle acceleration, deceleration (braking), and turning radius (steering) data, provided either by an operator, network, or autonomous system, are mathematically processed and transformed into a model of the target motion for the vehicle. The drive control computer processes the model into separate left and right target motor command signals and sends them to respective left and right electric motors attached to the respective front wheels, generating forces causing the wheels to rotate and move the vehicle. Measured data from wheel, inertial, and other sensors of vehicular movement are mathematically processed and transformed into a model of measured vehicular motion. The drive control computer uses a closed loop vehicular motional control algorithm to compare the two models and adjusts accordingly the respective power to the front wheels to maintain desired vehicle motion, so that the turn rate is controlled, maintaining the intended speed and direction, and oversteering does not occur. The rear wheel(s) at a minimum provide vertical support and permit x-y plane movement for the vehicle's tail end. Depending on their type and configuration, the rear wheel(s) can influence the vehicle handling dynamics by contributing lateral resistance and potentially assisting in the steering, stability, and/or propulsion of the vehicle.

It is therefore one objective of the present invention to provide a system and method of automatically steering a vehicle. It is another objective of the present invention to provide a system and method of automatically and safely steering a vehicle, having either three or four wheels, that is capable moving at a speed greater than 15 mph. It is a further objective of the present invention to provide a system and method of reducing the number of moving parts necessary in an automated steering system to reduce cost and increase reliability and maintainability from having fewer mechanical parts. It is still further an objective of the present invention to provide a system and method of automatically steering a vehicle that allows for a tight turning radius and greater maneuverability. It is still a further objective of the present invention to provide a system and method of automatically steering a vehicle that enables autonomous (unmanned) driving, where no user input is needed for steering the vehicle. It is still another objective of the present invention to provide a system and method of automatically, reliably, and safely steering a vehicle that enables widespread marketplace deployment of new technologies such as robotic taxis.

Other objects, embodiments, features and advantages of the present invention will become apparent from the following description of the embodiments, taken together with the accompanying drawings, which illustrate, by way of example, the principles of the invention.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a diagram illustrating functional components in an automated differentially steered vehicle disclosed herein;

FIG. 2 is a block diagram of an automated differential steering system disclosed herein;

FIG. 3 s a block diagram of a closed loop feedback controls disclosed herein;

FIG. 4 s a block diagram of a closed loop feedback controls disclosed herein; and

FIG. 5 is a geometry diagram illustrating dimensional relationships of functional components in an automated differentially steered vehicle disclosed herein.

Listing of Reference Numbers Associated with Drawings

| Ref | |
|---|---|
| No. | Element |
| 100 | Vehicle |
| 102 | Front section of vehicle 100 |
| 104 | Rear section of vehicle 100 |
| 106 | Left side of vehicle 100 |
| 108 | Right side of vehicle 100 |
| 114 | Rear wheel of vehicle 100 |
| 115 | Caster-type bearing of rear wheel 114 |
| 116 | Left front wheel of vehicle 100 |
| 118 | Right front wheel of vehicle 100 |
| 120 | Steering wheel of vehicle 100 |
| 122 | Brake of vehicle 100 |
| 124 | Throttle of vehicle 100 |
| 134 | Rear motor controller of vehicle 100 |
| 135 | Rear rotational motor controller of vehicle 100 |
| 136 | Left motor controller of vehicle 100 |
| 138 | Right motor controller of vehicle 100 |
| 144 | Rear electric motor of vehicle 100 |
| 145 | Rear rotational electric motor of vehicle 100 |
| 146 | Left electric motor of vehicle 100 |
| 148 | Right electric motor of vehicle 100 |
| 150 | Battery of vehicle 100 |
| 155 | Actuated clutch of caster-type bearing 115 |
| 200 | Automated differential vehicular steering system of vehicle 100 |
| 210 | Drive control computer of system 200 |
| 224 | Rear wheel sensor of system 200 |
| 225 | Rear wheel rotational angle sensor of system 200 |
| 226 | Left wheel sensor of system 200 |
| 228 | Right wheel sensor of system 200 |
| 230 | Inertial sensor of system 200 |
| 240 | Target vehicle motion input of system 200 |
| 242 | Steering input of target vehicle motion input 240 |
| 244 | Braking input of target vehicle motion input 240 |
| 246 | Acceleration input of target vehicle motion input 240 |
| 250 | Measured vehicle motion input of system 200 |
| 254 | Rear wheel input of measured vehicle motion input 250 |
| 255 | Rear wheel rotational angle input of measured vehicle motion |
| | input 250 |
| 256 | Left wheel input of measured vehicle motion input 250 |
| 258 | Right wheel input of measured vehicle motion input 250 |
| 260 | Inertial input of measured vehicle motion input 250 |
| 274 | Rear target motor command signal of drive control computer 210 |
| 275 | Rear target rotational motor command signal of drive control |
| | computer 210 |
| 276 | Left target motor command signal of drive control computer 210 |
| 278 | Right target motor command signal of drive control computer 210 |

### DETAILED DESCRIPTION

In the following description of the present invention, reference is made to the exemplary embodiments illustrating the principles of the present invention and how it is practiced. Other embodiments will be utilized to practice the present invention and structural and functional changes will be made thereto without departing from the scope of the present invention.

The present specification discloses an automated differential vehicular steering mechanism, framework, and software architecture for either three-wheeled or four-wheeled vehicles. The present invention is suitable for vehicles that travel at speeds exceeding 15 miles/hour, and is embodied in one or more systems and methods as described herein. The present invention may be styled and/or referred to herein as an automated differential vehicular steering system, but it shall be understood to encompass both systems and methods embodying a mechanism, framework, and software architecture for accomplishing automated differential wheel control of vehicles from a modeled response to characteristics of vehicular movement.

The automated differential vehicular steering system comprises, at its core, a drive control computer including a closed loop vehicular motional controller, a plurality of sensing systems comprised of one or more inertial sensors, one or more wheel sensors, and software for modeling a response to outputs from the plurality of sensing systems. The automated differential vehicular steering system is applicable to vehicles having two front wheels, with an electric motor and a wheel sensor, capable of measuring at least rotational speed and optionally wheel position, associated with each front wheel. Vehicles may have either one or two rear wheels, which allow movement along the x-y plane. The rear wheel(s) are associated with their own optional wheel sensor(s), actuated clutch(s), and/or electric motor(s). The differential vehicular steering system enables vehicles moving at greater than 15 mph to be automatically, safely, and reliably steered by preventing issues such as oversteering or fishtailing, thereby also enabling autonomous or unmanned operation of such vehicles. In some embodiments, a vehicle disclosed herein can move at speeds, e.g., greater than 15 mph, greater than 20 mph, greater than 25 mph, greater than 30 mph, greater than 35 mph, greater than 45 mph, or greater than 50 mph. In some embodiments, a vehicle disclosed herein can move at speeds, e.g., about 15 mph to about 20 mph, about 15 mph to about 25 mph, about 15 mph to about 30 mph, about 15 mph to about 35 mph, about 15 mph to about 40 mph, about 15 mph to about 45 mph, about 15 mph to about 50 mph, about 20 mph to about 25 mph, about 20 mph to about 30 mph, about 20 mph to about 35 mph, about 20 mph to about 40 mph, about 20 mph to about 45 mph, about 20 mph to about 50 mph, about 25 mph to about 30 mph, about 25 mph to about 35 mph, about 25 mph to about 40 mph, about 25 mph to about 45 mph, about 25 mph to about 50 mph, about 30 mph to about 35 mph, about 30 mph to about 40 mph, about 30 mph to about 45 mph, about 30 mph to about 50 mph, about 35 mph to about 40 mph, about 35 mph to about 45 mph, about 35 mph to about 50 mph, about 40 mph to about 45 mph, about 40 mph to about 50 mph, or about 45 mph to about 50 mph.

A closed loop vehicular motional controller of a drive control computer includes an algorithmic framework that is performed in conjunction with, and operates within, a computing environment in which one or more processors and a plurality of software and hardware components may be configured to execute program instructions or routines to perform the elements and data processing functions described herein and embodied in one or more algorithms to control electric motors associated with each wheel system. These algorithms, which may include but are not necessarily limited to proportional integral derivative (PID) types, are part of a proprietary environment in which one or more systems and methods are performed by applying mathematical functions, models or other analytical and data processing techniques that ensure that power is applied in an appropriate manner to each of the front wheels and rear wheel(s) (where applicable) separately and differentially in response to operating characteristics of the vehicle to effect changes in speed and direction thereof.

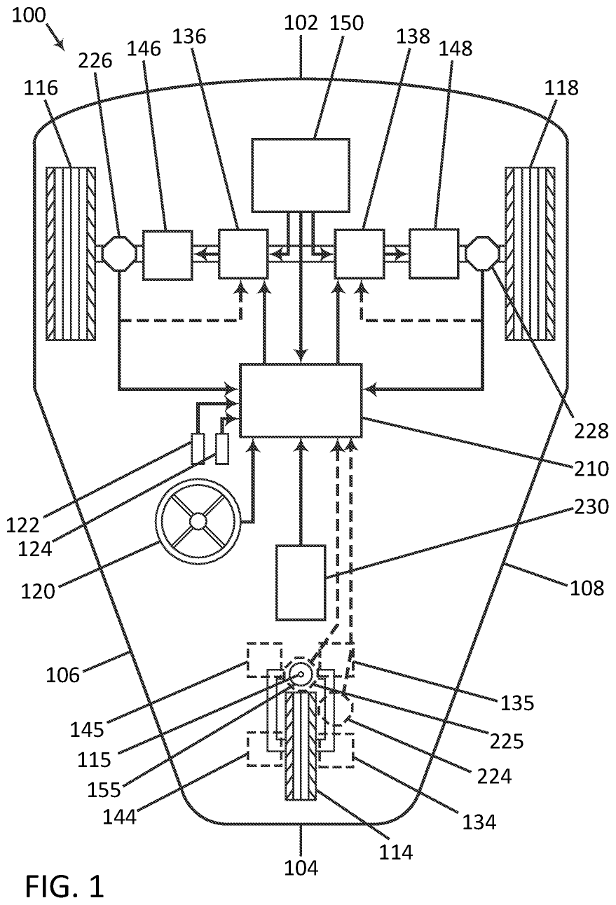

In some embodiments, and referring to FIGS. 1 & 2, an exemplary vehicle disclosed herein is three-wheeled vehicle 100, and an exemplary an automated differential vehicular steering system comprises an automated differential vehicular steering system 200 comprising a drive control computer 210. As shown in FIG. 1, vehicle 100 includes a front section 102, rear section 104, left side 106 and right side 108. Vehicle 100 also includes a left front wheel 116 which is operationally coupled to one or more electric motors, shown as a left electric motor 146, a right front wheel 118 which is operationally coupled to one or more electric motors, shown as a right electric motor 148, and a rear wheel 114. Left and right front wheels 116, 118 are capable of rotating only about the y-axis with the disc of left and right front wheels 116, 118 always lying in and fixed to the x-z plane. Rear wheel 114 is capable of allowing motion in the x-y plane, with the x-z plane movement being forward or rearward movement and the y-z plane movement being side-to-side movement. Rear wheel 114 can optionally be operationally coupled to one or more electric motors, shown as a rear electric motor 144. Additionally, or alternatively, rear wheel 114 can further comprise a caster-type bearing 115, which can optionally be coupled to an actuated clutch 155. Caster-type bearing 115, can optionally be operationally coupled to one or more rotational electric motors, shown as a rear rotational electric motor 145. Vehicle 100 further includes optional user controls including a steering wheel 120, a throttle 124, and a brake 122. As used herein, x-axis defines the direction parallel to the axis formed through front section 102 to rear section 104 of vehicle 100 and refers to forward and rearward direction relative to vehicle 100, y-axis defines the direction parallel to the axis formed through left side 106 to right side 108 of vehicle 100 and refers to side-to-side direction relative to vehicle 100, and z-axis defines the direction parallel to the axis formed through the top and bottom of vehicle 100 and refers to up and down direction relative to vehicle 100.

In some embodiments, rear wheel 114 can be of traditional design current used in society. In some embodiments, rear wheel 114 may be spherical, operating, such as for example, similar to that of a ball-point pen (not shown). In some embodiment, rear wheel 114 may be an omniwheel comprising of a plurality of rollers around a wheel's circumference which are perpendicular to the turning direction. With separate bearings for forward and lateral movement, an omniwheel has low rolling resistance in the forward rotational direction and variable or adjustable rolling resistance (such as through electric motors or electromagnetic fluid) in the lateral direction, thereby increasing the lateral handling capability of vehicle 100. An omniwheel may further be coupled to rear electric motor 144 to generate a longitudinal movement force on vehicle 100 in a coordinated effort with left and right front wheels 116, 118, thereby relieving and allowing more torque and power be available in left and right electric motors 146, 148 coupled to left and right front wheels 116, 118, respectively, for steering and stability. In another embodiment, rear wheel 114 may be coupled to rotational electric motor 145, which directly rotates the wheel about the z-axis in response to commands from a closed loop vehicular motional controller of drive control computer 210 to follow or assist, depending on the settings in the control algorithm, in steering vehicle 100 in a coordinated effort with left and right front wheels 116, 118 in response to changes in the rotational speed of one or more of left and right front wheels 116, 118 due to an adjustment in the amount of power provided thereto from their respective left and right motors 146, 148. Rear wheel 114 in this embodiment may be coupled to electric motor 144 to generate a movement force and assist left and right front wheels 116, 118 in moving vehicle 100.

Drive control computer 210 includes a closed loop vehicular motional controller which is coupled through one or more motor controllers. Motor controllers disclosed herein may be physically separate electronic devices, integrated into their respective motors, and/or included as part of drive control computer 210. For example, and referring to FIG. 1, vehicle 100 comprises left and right motor controllers 136, 138 and optionally rear wheel motor controller 134 and/or rear wheel rotational motor controller 135. Left and right motor controllers 136, 138 are coupled to left and right electric motors 146, 148, respectively and control the amount of power provided to their respective left and right wheels 116, 118. When rear wheel electric motor 144 is present, rear wheel motor controller 134 is coupled to rear wheel electric motor 144 for controlling the propulsion of rear wheel 114. When caster-type bearing 115 is present, rear wheel rotational motor controller 135 is coupled to rear rotational electric motor 145 for controlling the angular orientation of caster-type bearing 115 which in turn would control the angular orientation of rear wheel 114. In another embodiment, rear wheel rotational motor controller 135 is coupled to rear rotational electric motor 145 and directly controls the angular orientation about the z-axis of rear wheel 114. Drive control computer 210 can further include motor controllers for battery management, braking mechanism management as well as controllers for other types of data management obtained from sensors present in vehicle 100.

Vehicle steering is not (or at least not primarily) mechanical, but rather is controlled by software and processors present in a closed loop vehicular motional controller of drive control computer 210 that perform the algorithmic framework described herein. In addition, vehicle steering is not achieved by altering the z-axis direction of left and right front wheels 116, 118. Instead, steering is accomplished differentially by selectively applying more or less power (direct torque, not indirect torque) to each of left and right front wheels 116, 118 via its respective electric motors 146, 148, which alters the rotational speed and acceleration of left and right wheels 116, 118. This selective application of more or less power (resulting in direct torque on the particular wheel being rotated faster), causes vehicle 100 to turn about the z-axis with a turning radius along the axis of left and right front wheels 116, 118. For example, to steer vehicle 100 to the right, more power is applied to left electric motor 146 coupled to the left front wheel 116, causing it to rotate faster than right front wheel 118. This causes vehicle 100 to be steered to the right due to the increase in rotational speed resulting from more force on left front wheel 116. It should be noted that even though vehicle steering is not achieved by altering their z-axis direction, left and right front wheels 116, 118 do have minimal rotation about the z-axis, for what is needed for shock absorption and stability. Vehicle steering disclosed herein can result in a 90 degree turn by having one of left and right front wheels 116, 118 rotating in the opposite direction as the other one of left and right front wheels 116, 118. Besides controlling forces parallel to their direction of rolling, left and right front wheels 116, 118 are also capable of providing lateral reactive forces. Left and right front wheels 116, 118 also provide reactive vertical forces supporting front 102 of vehicle 100.

In vehicles with traditional Ackermann-based front wheel mechanical steering, the rear of the vehicle has wheels which allow for forward movement but provide reactive forces to lateral movement. Thus the stability of mechanically steered vehicles is passive and does not require active control. Stability control can be added to vehicles for situations where the forces exceed the passive capability of the systems, either due to extreme driving or reduced friction surfaces. Requiring that left and right front wheels 116, 118 provide stabilizing forces has two consequences: the total lateral acceleration capability of vehicle 100 is reduced (how fast can the vehicle make a turn for a given turning radius), and the loss of control of one of the two wheels means vehicle 100 will be unstable. Stability of vehicle 100 could be regained by the addition of a mechanical (hydraulic say) braking system which activate in the case of the loss of active wheel control (motor, motor controller, sensor loss). Inherent stability could also be achieved with a rear support system that was capable of providing lateral reaction forces. There are a multitude of options with a wide range of capabilities. The options are best laid out in terms of the forces the system is able to apply.

The purpose of rear wheel 114, at a minimum, is to provide vertical support to rear section 104 of vehicle 100. In some embodiments, rear wheel 114 can have a passive (zero force) configuration where rear wheel 114 or rear mechanism (e.g., caster-type bearing 115) provides no significance lateral reactive forces to provide stability or assist in steering of vehicle 100. Rear wheel 114 simply turns about a z-axis and follow the motion of vehicle 100, turning equally with same resistance in any direction. In this passive configuration left and right front wheels 116, 118, are responsible for all steering as well as providing the forces to produce a counter torque to keep the vehicle from rotating about the z-axis (yaw). Vehicle 100 comprising a passive configuration of rear wheel 114 lacks rear electric motor (for propulsion) 144, rear rotational electric motor (for changing the angle of the rear wheel relative to the vehicle direction of motion) 145, and actuated clutch (to fix the angle of the rear wheel) 156. Non-limiting examples of a rear wheel 114 having a passive configuration include a basic omniwheel, a ball/spherical wheel and a caster.

Alternatively, rear wheel 114 can be configured to employ one of several mechanisms that provide force in the lateral direction on the other side of the center of gravity from front wheels 116, 118 to assist with stability and/or steering of vehicle 100, including, without limitation, a reactive configuration, an actuated configuration, and an active configuration. In such embodiments, rear wheel 114 provides both a lateral force as part of the lateral forces and, more importantly, a torque to balance the torque forces that result from the lateral forces of front wheels 116, 118. Vehicle 100 comprising a reactive configuration, an actuated configuration, or an active configuration of rear wheel 114 typically exhibits lateral forces up to about 0.7 g.

In some embodiments, rear wheel 114 can provide lateral forces on the other side of the center of gravity from front wheels 116, 118 through a mechanism that varies the maximum amount of reactive force that rear wheel 114 can provide. In this embodiment the lateral force would be a passive reactive force which can be controlled in magnitude through an active control mechanism, thereby permitting changes in the rotation of vehicle 100 about the z-axis by reducing constraints on the rear wheel 114 to allow the rear wheel to translate as necessary or change alignment. In one embodiment, and as indicated in FIG. 1, rear wheel 114 includes a caster-type bearing 115 having actuated clutch mechanism 155 that limits when rear wheel 114 can turn about the z-axis. A reactive configuration does not generate forces required to initiate or control steering of vehicle 100. Non-limiting examples of a rear wheel 114 having a reactive configuration include an omniwheel whose controllable rollers may be locked or may have increased resistance to turning. Another example is a caster with a magnetically controlled fluid, a hydraulic clutch, or a friction clutch that, when engaged, allows the caster to not be able to rotate about the z-axis. Additionally such a mechanism can provide a resistance to turning about the z-axis to permit changes in turn radius and stabilizing lateral forces.

In some embodiments, rear wheel 114 can have an actuated configuration where rear wheel 114 or rear mechanism (e.g., caster-type bearing 115) is coupled with an electric motor, e.g., rear wheel rotational electric motor 145, to generate significance lateral reactive forces to rotate rear wheel 114 about a z-axis to match the turning radius initiated by left and right front wheels 116, 118 to provide stability of vehicle 100. This, while an actuated configuration disclosed herein provides forces to maintain the turn radius of vehicle 100, this configuration does not provide the forces necessary to change the turn radius (steering) of vehicle 100. Non-limiting examples of a rear wheel 114 having an actuated configuration include a motorized actuated wheel or a motorized actuated caster.

In some embodiments, rear wheel 114 can have an active configuration where rear wheel 114 or rear mechanism (e.g., caster-type bearing 115) is coupled with an electric motor, e.g., rear wheel rotational electric motor 145, to generate significance lateral reactive forces to rotate rear wheel 114 about a z-axis to match the turning radius initiated by left and right front wheels 116, 118 as well as to generate forces to assist in steering of vehicle 100. As such, vehicle 100 comprising an active configuration comprises rear wheel rotational electric motor 145 that can initiate a turn with rear wheel 114 in conjunction with left and right front wheels 116, 118, rotate rear wheel 114, prevent oversteering. Non-limiting examples of a rear wheel 114 having an active configuration include a motorized active wheel or a motorized active caster.

Additionally, in some embodiments with exception to the passive rear wheel configuration, an optional electric motor 144 coupled to rear wheel 114 can assist with the propulsion of vehicle 100 in conjunction with left and right front wheels 116, 118.

Vehicle 100 with which automated differential vehicular steering system 200 may also optionally include steering wheel 120, brake 122, and throttle 124. Steering wheel 120 is not solely mechanical, but rather is electro-mechanical. In response to a manipulation of steering wheel 120 (either by a user, or automatically in response to operation of vehicle 100), an electro-mechanical rotary encoder (optical, capacitive, or magnetically based, for example) generates a representative signal. Similarly, data signals from throttle 124 and/or brake 122 are generated by user action. Data signals from steering wheel 120, brake 122, and throttle 124 are mathematically processed and transformed into a model of target motion for the vehicle. This mathematical processing can be performed externally by a separate microprocessor and/or within drive control computer 210. Drive control computer 210 processes the model into separate left and right target motor command signals and sends them to respective left and right motor controllers 136, 138 powering left and right electric motors 146, 148 associated with each of left and right front wheels 116, 118 and, optionally, rear wheel 114 (via rear motor controller 134 and/or rear wheel rotational motor controller 135 powering respective rear and/or rotational electric motors 144, 145). Steering wheel 120 may therefore be used to control rotational speed of each front wheel and optionally rotation speed of and/or z-axis direction of rear wheel(s). In addition, automated differential vehicular steering system 200 enables a very small to zero turning radius because it is not geometrically and mechanically restricted as in traditional Ackermann-based mechanical steering with racks and control arms. In cities, 100 could park perpendicular to the sidewalk with a front door for safer entry/exiting and allow for tight side-by-side parking, saving space. Differential vehicular steering system 200 is entirely electronic “drive by wire” and speed sensitive steering logic can be included in drive control computer 210 to prevent tighter turns at higher speeds by progressively increasing the minimum allowable turning radius when compared with increasing vehicle speed.

The operation of vehicle 100 is not dependent upon the specifics of the energy storage or delivery. Any energy system capable of causing torques at the wheels sufficiently quickly with the ability to deliver or receive the resultant energy may be used. A battery system with electrical motors is one such capable system. A hybrid system of long-term energy storage with short term surge or bidirectional capability is also suitable, for example a hydrogen fuel cell paired with either batteries or ultra-capacitors. Long term energy could also come externally from wireless energy transfer buried in the road. In some embodiments, and referring to FIG. 1, an onboard battery 150 provides power to vehicle 100.

Vehicle 100 may also be equipped with a braking mechanism, which is not necessarily (or not solely) mechanical. Non-limiting examples of an electronic breaking mechanism, include regenerative and dynamic electromagnetic breaking, utilizing the counter electromotive force (CEMF) from the motors when acting as generators., Regenerative breaking converts vehicular kinetic energy into potential energy stored in a battery during the braking process. For regenerative breaking, the kinetic energy of moving vehicle 100 causes left and right electric motors 146, 148 of left and right wheels 116 and 118, respectively to rotate and generate CEMF and, when exceeding the voltage of battery 150, causes electrical current to flow out from left and right electric motors 146, 148 of left and right front wheels 116 and 118, through left and right motor controllers 136, 138 and into onboard battery 150, recharging it. Alternatively, vehicle braking may comprise an electronic breaking mechanism where the battery 150 is disconnected from left and right motor controllers 136, 138 of left and right electric motors 146, 148 and instead an electrically resistive load is applied across the motor controllers. The CEMF produced by the motors, now acting as generators, is resisted by the load, dissipated as heat, and the vehicle is slowed down. In this example, no energy is recovered during the braking process.

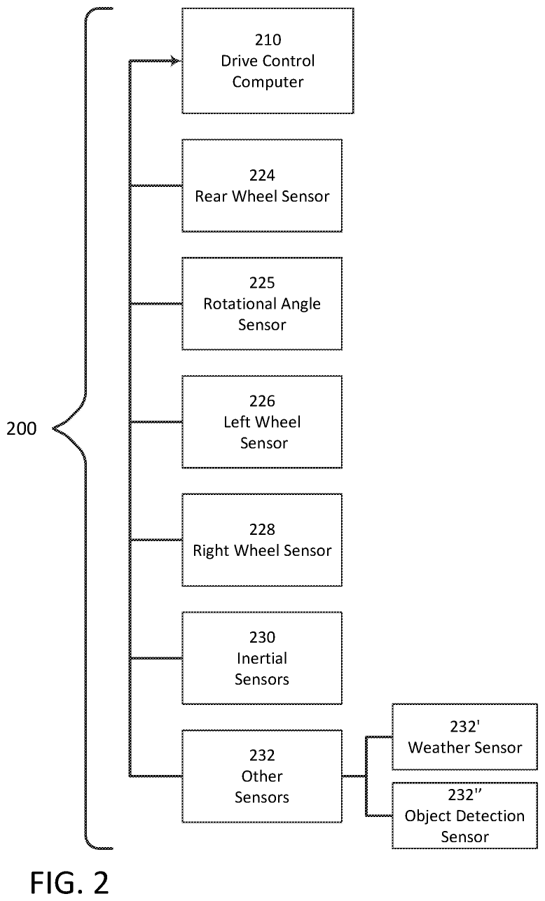

As shown in FIG. 2, automated differential vehicular steering system 200 comprises drive control computer 210, one or more-wheel sensors, shown as left wheel sensor 226, right wheel sensor 228, and optionally rear wheel sensor 224 and/or rear wheel rotational angle sensor 225, one or more inertial sensors 230, as well as one or more other sensors 232. In some embodiments, one or more other sensors 232 include a weather sensor 232′ and/or an object detection sensor. 232″.

Referring to FIGS. 1 & 3, left and right wheel sensors 226, 228 are coupled to left and right electric motors 146, 148, respectively or, alternatively, to left and right wheels 116 and 118 directly. Left and right wheel sensors 226, 228 are each configured separately to provide at least measurements associated with wheel speed and optionally, the position of their respective left and right wheels 116 and 118. Measured data from left and right front wheels 116, 118 are calculated into average longitudinal (forward) vehicle speed, turning radius, angular velocity, and angular acceleration. As shown in FIGS. 1 & 4, rear wheel sensor 224 may be coupled to rear electric motor 144, or, alternatively, to rear wheel 114. Rear wheel sensor 224 is configured to provide measurements associated with wheel speed and optionally, the position of rear wheel 114. As shown in FIGS. 1 & 4, rear wheel rotational angle sensor 225 may be coupled to rear rotational electric motor 145 and/or actuated clutch 155 or, alternatively, to caster-type bearing 115. Rear wheel rotational angle sensor 225 is configured to provide at least measurements associated with angular position about the z-axis of caster-type bearing 115 or rear wheel 114 directly.

Additionally, and referring to FIG. 2, automated differential vehicular steering system 200 includes one or more inertial sensors 230 configured to measure a comprehensive and suitably accurate measurement of a vehicle's orientation and movement including but not limited linear velocity and acceleration in the x, y, and z spaces, rotational or angular velocity and acceleration about the x, y, and z spaces (yaw, roll, and pitch). One or more inertial sensors 230 can comprise one or more gyro sensors, one or more accelerometers, one or more magnetometers, and one or more inertial measurement unit (IMU) sensors, or attitude and heading reference system (AHRS) sensors, and any combinations of one or more gyro sensors, one or more accelerometers, one or more magnetometers, one or more IMU sensors, and one or more AHRS sensor sensors. The outputs one or more inertial sensors 230 can be transformed to produce a measured model of motion of vehicle 100. The accelerometer output can be integrated to produce a velocity and integrated again to produce a position. Such integrations are subject to error accumulation but over the short term can be useful approximations. Similarly the gyroscope output can be differentiated to produce an angular acceleration and integrated to produce orientation (yaw, roll, pitch). Error accumulation from the gyroscope can be compensated by the use of the magnetometer and the accelerometer's gravity vector, since they together produce a direct local spatial orientation. The gyro, accelerometer, magnetometer, IMU and/or AHRS sensors need not be costly, bulky, and/or mechanically complex devices but can also be micro-electro-mechanical systems (MEMS) type, commonly used in drones, smart phones, and VR headsets.

Such combined inertial measurements from one or more inertial sensors 230 improve the performance of automated differential vehicular steering system 200 because the inclusion of additional sensors enhance the measurements taken solely by a single sensor with corresponding limitations. Gyroscopes tend to drift in reading and are better suited for shorter term measurements. In contrast, accelerometers tend to be noisy and are better suited to longer-term measurements. Therefore, in addition to the use of magnetometers to more accurately measure orientation in the present invention, data collected from the gyroscope and accelerometer are combined using one or more filters to eliminate unwanted and/or erroneous information, such as a Kalman filter or a complementary filter. In such a processing of the sensor data, the information from gyro is processed in a high-pass filter and the information from the accelerometer is processed in a low-pass filter, and weights are added to each type of information. The two weighted outcomes are then combined with measured data from other motional sensors in the analysis performed by a closed loop vehicular motional controller of drive control computer 210 to determine an appropriate adjustment of power to change the rotational speed of each of left and right front wheels 116, 118 and optionally rotational speed and/or rotational angle of rear wheel 114, if necessary.

Measurement information from left and right wheel sensors 226, 228, rear wheel sensor 224 and/or rear wheel rotational angle sensor 225 and the one or more inertial sensors 230 are relayed to one or more microprocessor of a closed loop vehicular motional controller of drive control computer 210, which then selectively and immediately regulates more or less power to each of left and right front wheels 116, 118 via their respective electric motors 146, 148 and optionally to rear wheel 114 via electric motor 144 and/or rotational motor 145 to provide stability to vehicle 100. This enables a controlled steer to compensate for or prevent vehicle oversteering. Constant input from left and right wheel sensors 226, 228, and optionally rear wheel sensor 224 and/or rear wheel rotational angle sensor 225 and one or more inertial sensors 230 results in a continuous adjustment of the motor command signals to left and right motor controllers 136, 138, and optionally rear motor controller 134 and/or rear wheel rotational motor controller 135 which supply corresponding pulse width modulations (PWM) of electrical current, to left and right electric motors 146, 148 of left and right front wheels 116, 118 and optionally to motor 144 and/or rotational motor 145 of rear wheel 114. This results in a feedback mechanism that enables stable, controlled and predictable steering and movement for the vehicle.

Automated differential vehicular steering system 200 may also include one or more other sensors 232 that are configured to perform supplementary inertial measurement of the vehicle. In some embodiments, other sensors 232 may be deployed in conjunction with automated differential vehicular steering system 200 to ensure that sensors designed to determine an amount of power applied to each of left and right front wheels 116, 118 and rear wheel 114 are working properly. For example, a weather or rain sensor 232′ may be implemented to compensate for situations where a rotational speed of each of left and right front wheels 116, 118 or rear wheel 114 is not proportional to the speed of vehicle 100, for example where excessive water is present on a roadway or other surface where vehicle 100 is operating. Another example is object detection sensors 232″ may also be deployed around vehicle 100 to prevent collision into adjacent vehicles while steering. It is therefore to be understood that many other types of sensors may be implemented with automated differential vehicular steering system 200. Drive control computer 210 may accept or otherwise obtain such external information for use as additional inputs in data processing for automated differential vehicular steering system 200, such as for example weather information or roadway condition data obtained from third party sources.

In addition, cameras, radar, LiDAR, and GPS are examples of other sensors 230 used to perform measurements of vehicle motion. Such other sensors 232 may help to provide the proper orientation and dynamic data to a closed loop vehicular motional controller of drive control computer 210 or other microprocessor. In one example, an inertial measurement unit (IMU) or an attitude and heading reference system (AHRS) is generated from a combination sensing unit that combines a gyroscope, an accelerometer, and a magnetometer, each of which measure characteristics of vehicular movement along the x, y, and z spaces. The addition of these further inertial measurements, and in particular the addition of the magnetometer sensor, provides an enhanced measure of vehicular yaw, and more accurately a measurement of yaw rate. This is particularly important where rear wheel 116 is an omniwheel and does not have an angle sensor coupled thereto.

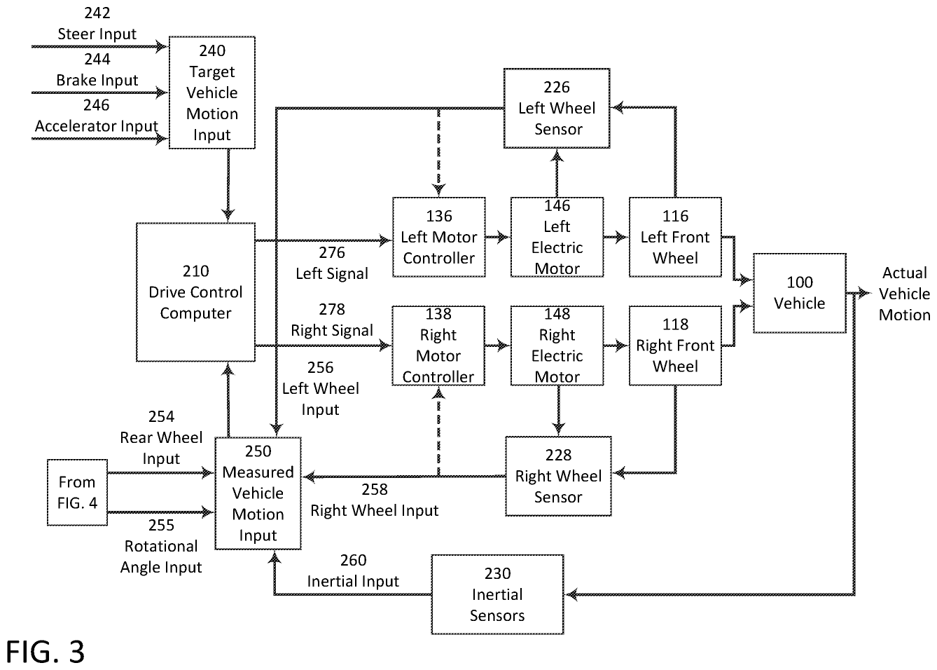

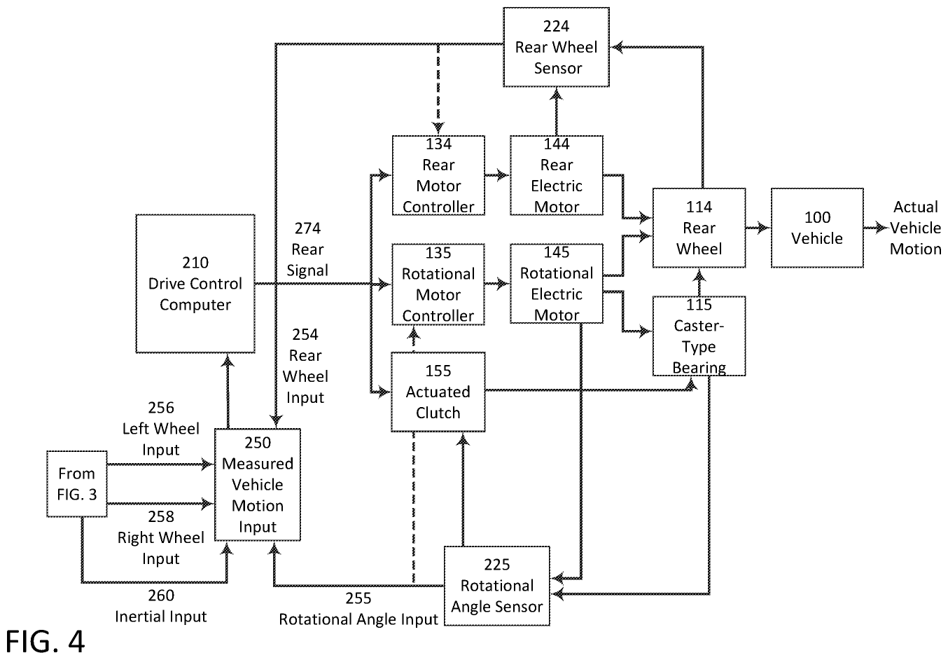

In some embodiments, drive control computer 210 comprises one or more closed loop wheel speed controller algorithm. In some embodiments, as shown in FIG. 3, drive control computer 210 comprises a left wheel closed loop wheel speed controller creating a loop between left wheel sensor 226, left motor controller 136, left electric motor 146, and optionally left front wheel 116. In some embodiments, as shown in FIG. 3, drive control computer 210 comprises a right wheel closed loop wheel speed controller creating a loop between right wheel sensor 228, right motor controller 138, right electric motor 148, and optionally right front wheel 118. In some embodiments, as shown in FIG. 4, drive control computer 210 comprises a rear wheel closed loop wheel speed controller creating a loop between rear wheel sensor 224, rear motor controller 134, rear electric motor 144, and optionally rear wheel 114. In some embodiments, as shown in FIG. 4, drive control computer 210 comprises a rear rotational angle wheel closed loop wheel speed controller creating a loop between rear rotational angle wheel sensor 225, rear rotational angle motor controller 135, rear rotational angle electric motor 145, and optionally caster-type bearing wheel 115.

Referring now to FIG. 3, a drive control computer 210 takes input data, e.g. target vehicle motion input 240 from a user operating vehicle 100, for example, a steering input 242, a brake input 244, and an accelerator input 246, and/or measured vehicle motion input 250 from automated differential vehicle steering system 200, such as, e.g., a left wheel input 256 from left wheel senor 226, right wheel input 258 from right wheel senor 228, and/or inertial input from one or more inertial sensors 230 (and if present, a rear wheel input from rear wheel sensor 224 and/or rotational angle sensor 225), and mathematically processes and transforms this information into a model of target motion for vehicle 100. This mathematical processing can be performed externally by a separate microprocessor and/or within drive control computer 210. Drive control computer 210 processes and sends this model information into separate left and right target motor command signals 276, 278 and sends them to respective left and right motor controllers 136, 138 which power electric motors 146, 148 attached to the respective left and right front wheels 116, 118, generating forces causing the wheels to roll and move vehicle 100 accordingly. Wheel speed data from left and right wheel sensors 226, 228 attached to left and right front wheels 116, 118 or their electric motors 146, 148 is fed back to drive control computer 210 and optionally left and right motor controllers 136, 138. The speed of left and right front wheels 116, 118 can be controlled through individual closed feedback loop algorithms either within drive control computer 210 or their respective left and right motor controllers 136, 138 to form a wheel speed-based vehicle control system. While vehicle 100 is moving, deviations from target wheel speeds caused by oversteer and/or other phenomena are measured via left and right wheel sensors 226, 228 and adjusted accordingly through their closed feedback control loops to maintain their respective target speeds and subsequently, the target vehicle motion of vehicle 100.

Similarly, and referring to FIG. 4, measured vehicle motion input 250 from automated differential vehicle steering system 200 can further include a rear wheel input 254 from rear wheel senor 224, and a rear rotational angle input 255 from rear wheel rotational angle senor 225, mathematically processes and transforms by drive control computer 210 into a model of target motion for vehicle 100. Drive control computer 210 processes and sends this model information as a rear target motor command signal 274 to rear motor controller 134 and rotational motor controller 135, which power respective electric motors 144, 145 attached to rear wheel 114, generating forces causing rear wheel 114 to roll and move vehicle 100 accordingly. Drive control computer 210 processes and sends this model information as a rear target motor command signal 274 to actuated clutch 155, which generates forces on caster-type bearing 115 to causing rear wheel 114 to roll and move vehicle 100 accordingly. Wheel speed data from rear wheel sensor 224 attached to rear wheels 114 or its electric motors 144 is fed back to drive control computer 210 and optionally rear motor controller 134. Wheel angle data from rear wheel rotational angle sensor 225 attached to caster-type bearing 115 or rotational angle electric motor 145 is fed back to drive control computer 210 and optionally rear rotational motor controller 135. The angular position and/or speed of rear wheel 114 can be controlled through individual closed feedback loop algorithms either within drive control computer 210 and optionally rear motor controller 134 and/or rear rotational motor controller 135 to form a wheel speed-based vehicle control system. While vehicle 100 is moving, deviations from target wheel speeds caused by oversteer and/or other phenomena are measured via rear wheel senor 224 and/or rear wheel rotational angle senor 225, and adjusted accordingly through their closed feedback control loops to maintain their respective target speeds and subsequently, the target vehicle motion of vehicle 100.

In some embodiments, drive control computer 210 comprises a closed loop vehicular motion control algorithm. For example, and continuing in reference to FIG. 3, alternatively or in tandem, inertial sensors 230 continuously monitor characteristics of vehicle movement and provide measurement data to drive control computer 210. Their data is mathematically processed and transformed into a model of measured motion for vehicle 100. This mathematical processing can be performed externally by a separate microprocessor and/or within drive control computer 210. Drive control computer 210 uses a closed loop vehicular motional control algorithm to compare a target motion model based on target vehicle motion input 240 with a measured motion model based on measured vehicle motion input 250 and adjusts accordingly the respective power going to left and right front wheels 116, 118 to maintain target vehicle motion, forming a measured motion-based vehicle control system. Unintended angular velocity and lateral accelerations to vehicle 100 caused by oversteer and external disturbances including bumps and dips in the roadway are detected and corrected through this motion-based control loop. This measured motion-based control system can be used as the vehicle's primary directional control system, a backup or supplement to a wheel-speed based control system.

For the wheel speed-based control system shown in FIG. 3, left and right front wheels 116, 118 are fixed in rotational direction and are independently powered by separate left and right electric motors 146, 148, respectively. Both steering and acceleration are achieved though control of motor commands via their motor controllers (speed->torque->current->PWM in brushless permanent magnet motors, for example). Geometry dictates that a given turning radius will require a certain speed difference between the inner and outer wheels. The acceleration of vehicle 100 is the rate of change of the speed with respect to time: dS/dt. Since target vehicle motion input 240, such as, e.g., steer 242, brake 244, accelerator/throttle 246, act on the speed of left and right wheels 116, 118 a speed target is calculated for each of left and right front wheels 116, 118 (S_target_left, S_target_right). Once vehicle 100 starts moving 210 compares 240 input with 250 to maintain 240's velocity, acceleration, and turning radius.

In some embodiments, calculation of wheel speed targets can be based on steering wheel angle input that maps to a turning radius. The turning radius can be defined from the center of the turning circle to somewhere in the range from the inner wheel, through the center of vehicle, to the outer wheel. The functionality of these choices will be seen later. The turning radius determines the difference of inner and outer wheel speeds through simple geometry. The output of the steering wheel is thus a delta S (difference in wheel speeds). The throttle input maps to a fraction of available torque. Given the mass of vehicle 100 and passengers, an acceleration can be calculated. This acceleration is the rate of change of the speed of the vehicle with respect to time dS/dt. Given a current speed, S, a new speed target can be formed: S_target=S_measured+dS/dt*delta_t_loop where delta_t_loop is the length of time from sending the target to the next target update.

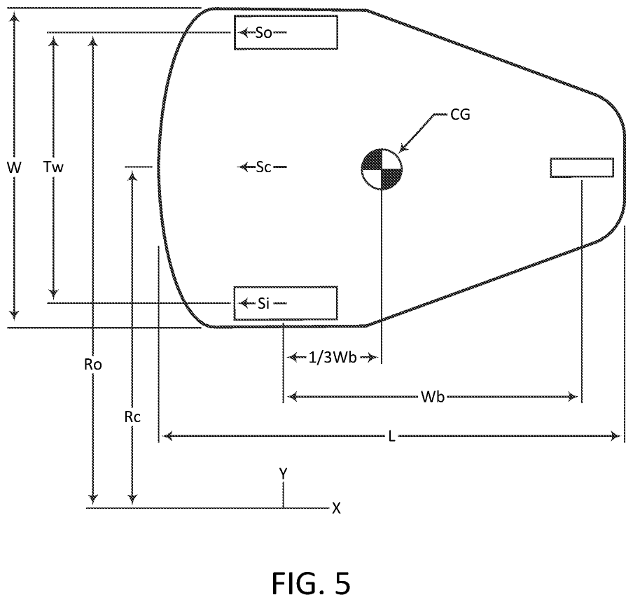

In some embodiments, and now referring to FIG. 5, drive control computer 210 controls a turn of vehicle 100 by applying algorithms using input 240 and 250. FIG. 5 shows that two turning radius algorithms are employed by drive control computer 210 for controlling the turning radius of vehicle 100. Each use different reference points when calculating target wheel speeds, namely a midway point turning radius algorithm and the outer wheel turning radius algorithm. A midway point turning radius algorithm disclosed herein using a point centered between the two front wheels as the turning radius end point. When employing a midway point turning radius algorithm disclosed herein, wheel speeds of left and right front wheels 116, 118 are determined using Equation 1 below:

So=Sc*(1+Tw/(2Rc))

Si=Sc*(1−Tw/(2Rc))

Sc=(So+Si)/2 Equation 1

where So is the speed of the outer wheel, Si is the speed of the inner wheel, Sc is the speed of the center of vehicle 100, Tw is the track width between left and right front wheels 116, 118, Rc is the radius from the center of the turning circle to the point midway between left and right front wheels 116, 118, and Rc range is infinite to >0. In this equation, the speed of the center of vehicle 100 does not change with turning radius. However, at a small turning radius, Rc approaches infinite speed causing vehicle 100 to spin unreasonably fast about its center resulting in unmanageable and impractical handling of vehicle 100. Thus, a midway point turning radius algorithm of Equation 1 stability controls a turn of vehicle 100 unless vehicle 100 engages in a turn with small radius.

To compensate for deficiency of midway point turning radius algorithm, an outer wheel turning radius algorithm is employed that uses the outer wheel of vehicle 100 as the turning radius end point. When employing an outer wheel turning radius algorithm disclosed herein, wheel speeds of left and right front wheels 116, 118 are determined using Equation 2 below:

So=So

Si=So*(1−Tw/Ro)

Sc=So*(1−Tw/(2Ro)) Equation 2

where So is the speed of the outer wheel, Si is the speed of the inner wheel, Sc is the speed of the center of vehicle 100. Tw is the track width between left and right front wheels 116, 118, Ro is the radius from the center of the turning circle to the outer wheel, and Ro range is infinite to Tw/2. At the minimum turning radius Tw/2, (i.e. zero turning radius), the speed of the center of vehicle 100 is zero. In this equation the speed of the center of vehicle 100 does change with turning radius. Sc is reduced with reduced turning radius. For larger turning radii this will not be noticeable and for very small turning radii, this is desirable. For moderate turning radii it may produce an undesirable sensation for the driver as turning may cause a feeling of deceleration. Thus, while an outer wheel turning radius algorithm disclosed herein addresses the small turn radius deficiencies of a midway point turning radius algorithm, it may produce undesirable behavior at moderate turning radii. Therefore, by combining both a midway point turning radius algorithm and an outer wheel turning radius algorithm, the beneficial effects of each turning radius algorithm can be achieved by taking a weighted combination of the two calculation methods such that at small turning radii the turning radius is controlled by an outer wheel turning radius algorithm disclosed herein and at large turning radii the turning radius is controlled by a midway point turning radius algorithm disclosed herein. In some embodiments, vehicle 100 comprising automated differential steering system 200 has a turning radius of, e.g. about 0 feet to infinite, about 1 foot to infinite, about 2 feet to infinite, about 3 feet to infinite, about 4 feet to infinite, or about 5 feet to infinite. In some embodiments, vehicle 100 comprising automated differential steering system 200 has a turning radius of, e.g. at least 0 feet to infinite, at least 1 foot to infinite, at least 2 feet to infinite, at least 3 feet to infinite, at least 4 feet to infinite, or at least 5 feet to infinite. Of course the turning radius is unlimited as vehicle 100 can drive straight and turn in the opposing direction.

Automated differential steering system 200 provides sufficient lateral acceleration to safety and responsibly perform on a road. On a skid pad used to test lateral acceleration handling capability of a vehicle, differential steering has the ability to maintain stability up to the point where the tires lose traction and vehicle spins out. This is commonly stated in units of g, referring to acceleration on the surface of the earth due to gravity being 32.2 ft/s². In the case of a differentially steered front wheel drive vehicle disclosed herein, the lateral acceleration handling capability is determined by primarily by the track width, distance of a vehicle's center of gravity behind the front wheels' rotational axis, coefficient of friction between the front wheels and rolling surface, and any lateral friction provided by the rear wheel(s). For example, FIG. 5 shows vehicle 100 comprising automated differential steering system 200 with vehicle 100 having a rear wheel with a passive configuration, and assuming vehicle 100 has the following characteristics: Length L of 96 inches; Width W of 72 inches; Track width Tw of 61 inches, with Tw being the distance between the centerline of left and right wheels; Wheelbase Wb of 61.5 inch, with Wb being the distance from the center of left and right front wheels to the center axis of rear wheel; Center of gravity CG as indicated in FIG. 5; Equal weight is distributed among left and right front wheels and rear wheel; and one-third the distance ⅓Wb is 20.5 inches behind left and right wheels. If one then presumes that a typical tire to dry road surface coefficient of friction of 0.7 and no lateral friction provided by the rear wheel, then the calculated lateral acceleration handling ability vehicle 100 is 0.39 g. If vehicle 100 now has a rear wheel with a reactive configuration, then the calculated lateral acceleration handling ability vehicle 100 is 0.5 g. If vehicle 100 now has a rear wheel with an actuated or an active configuration, then the calculated lateral acceleration handling ability of vehicle 100 is 0.7 g.

Although a vehicle employing Ackerman steering has higher lateral acceleration stability, typically 0.8 g to 0.90 g, such vehicles have a limited turning radius, typically about 19-20 feet. In addition, city roads are designed and made such that when driven within posted speed limits, the lateral acceleration typically experienced is within the range of 0.15 g to 0.35 g, which is within the handling capability of an automated differentially steered vehicle disclosed herein. Adding to this and unlike an amusement park roller coaster ride, most passengers of an autonomous robotic taxi would not be comfortable riding in an unmanned vehicle driving more aggressively and generating higher lateral accelerations than this. Thus, having a lateral acceleration capability of 0.39 to 0.70 g (depending upon embodiment) and zero turning radius, vehicle 100 is capable and advantageous for city roads, city limits and city speeds.

It is to be understood that there are many benefits to the design of a differential vehicular steering system disclosed herein. For example, a differential vehicular steering system realizes a substantial reduction in moving parts of a vehicle. This results in less complexity and less maintenance, and accordingly fewer costs, as well as less movable mass associated with operating a vehicle generally, so that the amount of power needed to effect a change in direction or speed when applied to the front wheel and rear wheels is less than would be needed for a vehicle having a larger mass due to the present of more mechanical parts. For example, in the present invention, many mechanical parts associated with a conventional motorized vehicle are not needed. There is no steering column or steering rack, as the optional steering wheel connects to an electronic rotary encoder, similar to those used for driving simulator consoles. Also, with braking being primarily electronic and regenerative, mechanical braking will take a secondary role, thereby being used less leading to longer lifespan and less maintenance costs.

Another benefit is improved efficiency. Looking down on the vehicle body in FIGS. 1 & 5, it could have a tapering body profile, being wider at the front and narrowing towards the rear to improve aerodynamics and be beneficial when turning with adjacent vehicles/objects. Since the front wheels only allow movement in the x-axis, and do not turn horizontally about a z-axis as traditionally steered vehicles do, all the wheels can be covered/skirted for superior vehicular aerodynamics. Together with the horizontally tapered body profile, operating efficiency in increased, thereby consuming fewer kWh of electricity per mile. A target range can thus be achieved while using a smaller, lighter, less costly battery.

Other benefits to the design of the present invention include greater maneuverability. For example, vehicles having the differential vehicular steering system of the present invention have a tighter turning radius as opposed to vehicles having a conventional Ackerman-based mechanical steering mechanism design, meaning that operability characteristics can improved substantially. For example, in cities a vehicle in accordance of the present invention could park perpendicular to the sidewalk with a front door for safer entry/exiting and allow for tight side-by-side parking, saving space. Additionally, vehicles such as off-road agricultural equipment often have very large tires and axles, and such vehicles need greater available space and time for steering. Using the differential vehicular steering system of the present invention, steering characteristics may change substantially, resulting in improvements in resource usage and increases in productivity.

The design of automated differential vehicular steering system 200 also enables improvements in autonomous or unmanned driving, as no user input is needed for steering. For example, in one exemplary embodiment, differential vehicular steering system 200 may be useful when implemented in vehicles such as robotic taxis.

Automated differential vehicular steering system 200 may also include one or more elements of artificial intelligence and machine learning in the algorithmic framework performed by a closed loop vehicular motional controller of drive control computer 210 for determining characteristics such as the amount of power applied to the front wheels and rear wheel(s). In this application of artificial intelligence and machine learning, a set of training data is developed from operating characteristics experienced by vehicle 100, and is implemented to improve correlations between the various types of input data to predict responses to particular conditions when detected by the plurality of sensors.

The algorithmic framework of an automated differential vehicular steering system disclosed herein may, for example, include one or more neural network to associate and compare variables in data collected by the plurality of sensors, and identify relationships in such data to improve responses to vehicular characteristics such as pitch, roll, tilt, yaw, yaw rate, and acceleration. The algorithmic framework of the present invention contemplates that the relationships among the various types of data in the plurality of sensors may be identified and developed by training the neural network to continually analyze input data, to build a more comprehensive dataset that can be used to make improvements to the outputs generated by the closed loop vehicular motional controller.

For instance, the application of artificial intelligence and machine learning in a differential vehicular steering system disclosed herein can be applied to an adequately sized dataset to draw automatic associations and identify relationships between the available data, effectively yielding a customized neural network for simulating a response to vehicular operating conditions, or for modeling a response for particular types of vehicles or for vehicles operating in particular environments. As more and more data are accumulated, the information can be sub-sampled, the neural network retrained, and the results tested against independent data (for example, from other vehicles operating with similar conditions) to further improve response. Further, this may yield information as to the importance of related factors through weighting of variables between inputs (such as in weighting outcomes from high-pass filtered gyro data and low-pass filtered accelerometer data), and may be further used to identify which factors would be particularly important or unimportant in determining an amount of power applied differentially to each front and/or rear wheel, and thus help to target ways of improving the neural network over time.

The present invention contemplates that many different types of artificial intelligence and machine learning may be employed, and are within the scope thereof. The application of artificial intelligence and machine learning may include, in addition or lieu of the neural network, one or more of such types of artificial intelligence. These may include, but are not limited to, techniques such as k-nearest neighbor (KNN), logistic regression, support vector machines or networks (SVM), and instantiations of one or more other types of machine learning paradigms such as supervised learning, unsupervised learning and reinforcement learning. Regardless, the use of artificial intelligence in the algorithmic framework of the present invention enhances the utility of data processing functions performed therein by automatically and heuristically constructing appropriate relationships, mathematical or otherwise, relative to the complex interactions between data obtained from the plurality of sensors and other input data used by a drive control computer, to arrive at the most appropriate response to particular vehicular operating conditions.

The systems and methods for performing the differential vehicular steering system of the present invention may be implemented in many different computing environments. For example, a permissioned, distributed ledger may be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, and any comparable means. In general, any means of implementing the methodology illustrated herein can be used to implement the various aspects of the present invention. Exemplary hardware that can be used for the present invention includes computers, handheld devices, telephones (e.g., cellular, Internet enabled, digital, analog, hybrids, and others), and other such hardware. Some of these devices include processors (e.g., a single or multiple microprocessors), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, artificial intelligence, fuzzy logic, expert system or combination of hardware and software that is capable of performing the data processing functionality described herein.

Aspects of the present specification can be described as follows:
1. A vehicle comprising an automated vehicular steering system, comprising: a) the vehicle having i) a first and a second front wheel and at least one rear wheel, the first front wheel being coupled to a first electric motor and the second front wheel being coupled to a second electric motor; ii) a center of gravity located between the first and second front wheels and the rear wheel; iii) a plurality of sensors, the plurality of sensors including a first wheel sensor configured to analyze speed for the first front wheel, a second wheel sensor configured to analyze speed for the second front wheel, and one or more inertial sensors configured to measure vehicular movement characteristics of the vehicle; and b) a differential vehicular steering system comprising a drive control computer including a closed loop vehicular motional controller coupled to the first and second electric motors; wherein the closed loop vehicular motional controller includes an algorithmic framework comprised of at least one of a vehicular speed control algorithm and a vehicular motion control algorithm configured to analyze information collected by the plurality of sensors to model one or both of a target speed and a target movement of the vehicle, and generate a responsive target motor command signal to at least one of the first and second electric motors to differentially adjust power applied by the first and second electric motor to the first and second front wheels respectively to conform to the one or both of the target speed and the target movement of the vehicle, thereby causing the vehicle to steer in a desired direction and provide stable travel.
2. The vehicle of embodiment 1, wherein the plurality of sensors further include one or more gyroscope sensors, one or more accelerometer sensors, one or more magnetometer sensors, one or more inertial measurement unit (IMU) sensors, one or more attitude and heading reference system (AHRS) sensors, or any combination thereof.
3. The vehicle of embodiment 1 or 2, wherein the at least one rear wheel is a caster-type wheel or an omniwheel.
4. The vehicle of embodiment 3, wherein the omniwheel has adjustable lateral rolling resistance.
5. The vehicle of any one of embodiments 1-4, wherein the at least one rear wheel is coupled to a z-axis rotational actuated clutch.
6. The vehicle of any one of embodiments 1-5, wherein the at least the rear wheels is coupled to a z-axis rotational motor.
7. The vehicle of any one of embodiments 1-6, wherein the at least one rear wheel is further coupled to propulsion motor.
8. The vehicle of any one of embodiments 1-7, wherein speed of the first and second front wheels are each controlled through closed feedback loop control algorithm.
9. An automated differential vehicular steering system comprising a drive control computer including a closed loop vehicular motional controller coupled to one or more electric motors associated with each of the plurality of front wheels of a vehicle and a plurality of sensors and configured to perform at least one of a vehicular speed control algorithm and a vehicular motion control algorithm to analyze one or both of a target speed and a target movement of the vehicle, the plurality of sensors including wheel sensors configured to analyze speed for each of the front wheels, and one or more inertial sensor(s) configured to measure one or both of vehicular speed and vehicular movement characteristics, the drive control computer configured to generate a command signal to at least one of the first and second electric motors to conform to the one or both of the target speed and the target movement of the vehicle.
10. The differential vehicular steering system of embodiment 9, wherein speeds of the front wheels are controlled through closed feedback loop control algorithms.
11. The differential vehicular steering system of embodiment 9 or 10, wherein the drive control computer further controls a z-axis rotational actuated clutch.
12. The differential vehicular steering system of any one of embodiments 9-11, wherein the drive control computer is further coupled to the one or more electric motors associated the at least one rear wheel.
13. A method for automatically steering a vehicle, comprising sensing, in a plurality of sensors associated with a vehicle having a plurality of front wheels and at least one rear wheel, a plurality input data representing a speed for each of the front wheels, and one or more characteristics of vehicular movement characteristics; modeling, within a drive control computer including a closed loop vehicular motional controller coupled to electric motors associated with each of the plurality of front wheels, the plurality of input data to determine a differential adjustment power applied to the plurality of front wheels to steer the vehicle in a desired direction, by performing at least one of a vehicular speed control algorithm and a vehicular motion control algorithm to analyze one or both of a target speed and a target movement of the vehicle; and generating one or more instructions from the closed loop vehicular motional controller to the electric motors to conform to the one or both of the target speed and the target movement of the vehicle.
14. The method of embodiment 14, wherein the closed loop vehicular motional controller is a proportional integral derivative (PID) controller.

Aspects of the present specification can be described as follows:
1. A vehicle comprising an automated differential vehicular steering system, comprising: a) the vehicle having i) a first and a second front wheel and at least one rear wheel, the first front wheel being operationally coupled to a first electric motor and the second front wheel being operationally coupled to a second electric motor, and the first front and second front wheels each capable of rotating only in the y-axis with disc of first and second front wheels always lying in and fixed to the x-z plane, and the rear wheel capable of allowing motion in the x-y plane; ii) a center of gravity located between the first and second front wheels and the rear wheel; iii) a plurality of sensors configured to continuously measured vehicle motion input data, the plurality of sensors including a first wheel sensor configured to continuously measure at least wheel speed and position from the first front wheel, a second wheel sensor configured to continuously measure at least wheel speed and position from the second front wheel, and one or more inertial sensors configured to continuously measure vehicular movement characteristics of the vehicle; b) the automated differential vehicular steering system comprising a drive control computer operating a closed loop vehicular motional controller operationally configured to differentially control rotational movement of at least the first and second front wheels, the closed loop vehicular motional controller performing the steps of: i) receiving target vehicle motion input data obtained from an operator and/or measured vehicle motion input data obtained from the plurality of sensors; ii) transforming obtained target vehicle motion input data and obtained measured vehicle motion input data into a model of target motion for the vehicle; iii) sending separate first and second target motor command signals to first and second electric motors, respectively to generate forces causing respective first and second wheels to rotate and move vehicle; wherein the vehicle is capable moving at a speed or 15 mph or more, and wherein the vehicle is capable of a turning radius with respect to a point midway between the first and second front wheels of zero feet to infinite.
2. The vehicle of embodiment 1, wherein the first electric motor is operationally coupled to a first motor controller.
3. The vehicle of embodiment 1 or 2, wherein the second electric motor is operationally coupled to a second motor controller.
4. The vehicle of any one of embodiments 1-3, wherein the at least one rear wheel is a caster-type wheel or an omniwheel.
5. The vehicle of any one of embodiments 1-4, wherein the omniwheel has adjustable lateral rolling resistance.
6. The vehicle of any one of embodiments 1-5, wherein the at least one rear wheel further rotates about the z-axis and is operationally coupled to a rotational actuated clutch capable of enabling or restricting rotation about the z-axis.
7. The vehicle of any one of embodiments 1-6, wherein the at least one rear wheel is operationally coupled to a rear rotational electric motor capable of rotating the at least one rear wheel about the z-axis.
8. The vehicle of any one of embodiments 1-7, wherein the at least one rear wheel is operationally coupled to a rear electric motor capable of generating propulsion force in the x-y plane.
9. The vehicle of any one of embodiments 1-8, wherein the plurality of sensors further include one or more gyroscope sensors, one or more accelerometer sensors, one or more magnetometer sensors, one or more inertial measurement unit (IMU) sensors, one or more attitude and heading reference system (AHRS) sensors, or any combination thereof.
10. The vehicle of any one of embodiments 1-9, wherein the closed loop vehicular motional controller comprises a first wheel closed loop wheel speed controller operationally configured to control rotational movement of the first front wheel and a second wheel closed loop wheel speed controller operationally configured to control rotational movement of the second front wheel.
11. The vehicle of any one of embodiments 1-10, wherein the closed loop vehicular motional controller comprises a rear wheel closed loop wheel speed controller operationally configured to control rotational movement of the at least one rear wheel.
12. The vehicle of any one of embodiments 1-11, wherein the closed loop vehicular motional controller comprises a rear rotational angle wheel closed loop wheel controller operationally configured to control rotational angular movement of the at least one rear wheel about the z-axis.
13. The vehicle of any one of embodiments 1-12, capable of autonomous operation while driving.
14. An automated differential vehicular steering system comprising a drive control computer operating a closed loop vehicular motional controller, the closed loop vehicular motional controller coupled to a first and a second electric motor and a plurality of sensors, and operationally configured to differentially control the first and second electric motors, wherein the first and second electric motors are associated with a first and a second front wheel respectively, wherein the closed loop vehicular motional controller performing the steps of: a) receiving target vehicle motion input data obtained from an operator and/or measured vehicle motion input data obtained from the plurality of sensors; b) transforming obtained target vehicle motion input data and obtained measured vehicle motion input data into a model of target motion for the vehicle; c) sending separate first and second target motor command signals to first and second electric motors, respectively to generate forces causing respective first and second front wheels to rotate and move vehicle.
15. The differential vehicular steering system of embodiment 14, wherein the plurality of sensors further include one or more gyroscope sensors, one or more accelerometer sensors, one or more magnetometer sensors, one or more inertial measurement unit (IMU) sensors, one or more attitude and heading reference system (AHRS) sensors, or any combination thereof.
16. The differential vehicular steering system of embodiment 14 or 15, wherein the closed loop vehicular motional controller comprises a first wheel closed loop wheel speed controller operationally configured to control rotational movement of the first front wheel and a second wheel closed loop wheel speed controller operationally configured to control rotational movement of the second front wheel.
17. The differential vehicular steering system of any one of embodiments 14-16, wherein the closed loop vehicular motional controller comprises a rear wheel closed loop wheel speed controller operationally configured to control rotational movement of the at least one rear wheel.
18. The differential vehicular steering system of any one of embodiments 14-17, wherein the closed loop vehicular motional controller comprises a rear rotational angular wheel closed loop wheel controller operationally configured to control rotational angular movement of the at least one rear wheel about the z-axis.
19. A method for automatically steering a vehicle, comprising sensing, in a plurality of sensors associated with a vehicle having a first and second front wheel and at least one rear wheel, a plurality input data representing a speed for each of the first and second front wheels, and one or more characteristics of vehicular movement characteristics; modeling, within a drive control computer including a closed loop vehicular motional controller coupled to electric motors associated with each of the left and right front wheels, the plurality of input data to determine a differential adjustment power applied to each of the first and second front wheels to steer the vehicle in a desired direction, by performing at least one of a vehicular speed control algorithm and a vehicular motion control algorithm to analyze one or both of a target speed and a measured movement of the vehicle to obtain a model of target motion for the vehicle; and generating one or more instructions from the closed loop vehicular motional controller to the electric motors to conform to the model of target motion for the vehicle.

In closing, it is to be understood that, although aspects of the present specification are highlighted by referring to specific embodiments, one skilled in the art will readily appreciate that these described embodiments are only illustrative of the principles of the subject matter disclosed herein. The specific embodiments are not intended to be exhaustive or to limit the invention to the precise forms disclosed. Therefore, it should be understood that the disclosed subject matter is in no way limited to a particular compound, composition, article, apparatus, methodology, protocol, and/or reagent, etc., described herein, unless expressly stated as such. In addition, those of ordinary skill in the art will recognize that certain changes, modifications, permutations, alterations, additions, subtractions and sub-combinations thereof can be made in accordance with the teachings herein without departing from the spirit of the present specification. It is therefore intended that the scope of the invention is not to be limited by this detailed description. Furthermore, it is intended that the following appended claims and claims hereafter introduced are interpreted to include all such changes, modifications, permutations, alterations, additions, subtractions and sub-combinations as are within their true spirit and scope.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified, thus fulfilling the written description of all Markush groups used in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. For instance, as mass spectrometry instruments can vary slightly in determining the mass of a given analyte, the term “about” in the context of the mass of an ion or the mass/charge ratio of an ion refers to +/−0.50 atomic mass unit. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as, e.g., “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising”, variations thereof such as, e.g., “comprise” and “comprises”, and equivalent open-ended transitional phrases thereof like “including,” “containing” and “having”, encompass all the expressly recited elements, limitations, steps, integers, and/or features alone or in combination with unrecited subject matter; the named elements, limitations, steps, integers, and/or features are essential, but other unnamed elements, limitations, steps, integers, and/or features may be added and still form a construct within the scope of the claim. Specific embodiments disclosed herein may be further limited in the claims using the closed-ended transitional phrases “consisting of” or “consisting essentially of” (or variations thereof such as, e.g., “consist of”, “consists of”, “consist essentially of”, and “consists essentially of”) in lieu of or as an amendment for “comprising.” When used in the claims, whether as filed or added per amendment, the closed-ended transitional phrase “consisting of” excludes any element, limitation, step, integer, or feature not expressly recited in the claims. The closed-ended transitional phrase “consisting essentially of” limits the scope of a claim to the expressly recited elements, limitations, steps, integers, and/or features and any other elements, limitations, steps, integers, and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps, integers, and/or features specifically recited in the claim, whereas the meaning of the closed-ended transitional phrase “consisting essentially of” is being defined as only including those elements, limitations, steps, integers, and/or features specifically recited in the claim and those elements, limitations, steps, integers, and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such, the embodiments described herein or so claimed with the phrase “comprising” expressly and unambiguously provide description, enablement, and support for the phrases “consisting essentially of” and “consisting of.”

All patents, patent publications, and other references cited and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard is or should be construed as an admission that the inventors are not entitled to antedate such disclosure by virtue of prior invention or for any other reason. All statements as to the date or representation as to the contents of these documents are based on the information available to the applicant and do not constitute any admission as to the correctness of the dates or contents of these documents.

Lastly, the terminology used herein is for the purpose of describing particular embodiments only and is not intended to limit the scope of the present invention, which is defined solely by the claims. Accordingly, the present invention is not limited to that precisely as shown and described.

1. A vehicle comprising an automated differential vehicular steering system, comprising:
a) the vehicle having
i) a first and a second front wheel and at least one rear wheel, the first front wheel being operationally coupled to a first electric motor and the second front wheel being operationally coupled to a second electric motor, and the first front and second front wheels each capable of rotating only in the y-axis with disc of first and second front wheels always lying in and fixed to the x-z plane, and the rear wheel capable of allowing motion in the x-y plane;
ii) a center of gravity located between the first and second front wheels and the rear wheel;
iii) a plurality of sensors configured to continuously measure vehicle motion input data, the plurality of sensors including a first wheel sensor configured to continuously measure at least wheel speed or position from the first front wheel, a second wheel sensor configured to continuously measure at least wheel speed or position from the second front wheel, and one or more inertial sensors configured to continuously measure vehicular movement characteristics of the vehicle;
b) the automated differential vehicular steering system comprising a drive control computer operating a closed loop vehicular motional controller operationally configured to differentially control rotational movement of at least the first and second front wheels, the closed loop vehicular motional controller performing the steps of:
i) receiving target vehicle motion input data obtained from an operator and/or measured vehicle motion input data obtained from the plurality of sensors;
ii) transforming obtained target vehicle motion input data and obtained measured vehicle motion input data into a model of target motion for the vehicle;
iii) sending separate first and second target motor command signals to first and second electric motors, respectively to generate forces causing respective first and second wheels to rotate and move the vehicle;
wherein the vehicle is capable moving at a speed or 15 mph or more, and
wherein the vehicle is capable of a turning radius with respect to a point midway between the first and second front wheels of zero feet to infinite.

2. The vehicle of claim 1, wherein the first electric motor is operationally coupled to a first motor controller.

3. The vehicle of claim 1, wherein the second electric motor is operationally coupled to a second motor controller.

4. The vehicle of claim 1, wherein the at least one rear wheel is a caster-type wheel or an omniwheel.

5. The vehicle of claim 4, wherein the omniwheel has adjustable lateral rolling resistance.

6. The vehicle of claim 1, wherein the at least one rear wheel further rotates about the z-axis and is operationally coupled to a rotational actuated clutch capable of enabling or restricting rotation about the z-axis.

7. The vehicle of claim 1, wherein the at least one rear wheel is operationally coupled to a rear rotational electric motor capable of rotating the at least one rear wheel about the z-axis.

8. The vehicle of claim 1, wherein the at least one rear wheel is operationally coupled to a rear electric motor capable of generating propulsion force in the x-y plane.

9. The vehicle of claim 1, wherein the plurality of sensors further include one or more gyroscope sensors, one or more accelerometer sensors, one or more magnetometer sensors, one or more inertial measurement unit (IMU) sensors, one or more attitude and heading reference system (AHRS) sensors, or any combination thereof.

10. The vehicle of claim 1, wherein the closed loop vehicular motional controller comprises a first wheel closed loop wheel speed controller operationally configured to control rotational movement of the first front wheel and a second wheel closed loop wheel speed controller operationally configured to control rotational movement of the second front wheel.

11. The vehicle of claim 1, wherein the closed loop vehicular motional controller comprises a rear wheel closed loop wheel speed controller operationally configured to control rotational movement of the at least one rear wheel.

12. The vehicle of claim 1, wherein the closed loop vehicular motional controller comprises a rear rotational angle wheel closed loop wheel controller operationally configured to control rotational angular movement of the at least one rear wheel about the z-axis.

13. The vehicle of claim 1, capable of autonomous operation while driving.

14. An automated differential vehicular steering system comprising a drive control computer operating a closed loop vehicular motional controller
the closed loop vehicular motional controller coupled to a first and a second electric motor and a plurality of sensors, and operationally configured to differentially control the first and second electric motors, wherein the first and second electric motors are associated with a first and a second front wheel respectively, wherein the closed loop vehicular motional controller performing the steps of:
a) receiving target vehicle motion input data obtained from an operator and/or measured vehicle motion input data obtained from the plurality of sensors;
b) transforming obtained target vehicle motion input data and obtained measured vehicle motion input data into a model of target motion for the vehicle;
c) sending separate first and second target motor command signals to first and second electric motors, respectively to generate forces causing respective first and second front wheels to rotate and move the vehicle.

15. The differential vehicular steering system of claim 14, wherein the plurality of sensors further include one or more gyroscope sensors, one or more accelerometer sensors, one or more magnetometer sensors, one or more inertial measurement unit (IMU) sensors, one or more attitude and heading reference system (AHRS) sensors, or any combination thereof.

16. The differential vehicular steering system of claim 14, wherein the closed loop vehicular motional controller comprises a first wheel closed loop wheel speed controller operationally configured to control rotational movement of the first front wheel and a second wheel closed loop wheel speed controller operationally configured to control rotational movement of the second front wheel.

17. The differential vehicular steering system of claim 14, wherein the closed loop vehicular motional controller comprises a rear wheel closed loop wheel speed controller operationally configured to control rotational movement of the at least one rear wheel.

18. The differential vehicular steering system of claim 14, wherein the closed loop vehicular motional controller comprises a rear rotational angle wheel closed loop wheel controller operationally configured to control rotational angular movement of the at least one rear wheel about the z-axis.

19. A method for automatically steering a vehicle, comprising
sensing, in a plurality of sensors associated with a vehicle having a first and second front wheel and at least one rear wheel, a plurality input data representing a speed for each of the first and second front wheels, and one or more characteristics of vehicular movement characteristics;
modeling, within a drive control computer including a closed loop vehicular motional controller coupled to electric motors associated with each of the left and right front wheels, the plurality of input data to determine a differential adjustment power applied to each of the first and second front wheels to steer the vehicle in a desired direction, by performing at least one of a vehicular speed control algorithm and a vehicular motion control algorithm to analyze one or both of a target speed and a measured movement of the vehicle to obtain a model of target motion for the vehicle; and
generating one or more instructions from the closed loop vehicular motional controller to the electric motors to conform to the model of target motion for the vehicle.
